(19) United States
(12) Patent Application Publication
(10) Pub. No.: US 2014/0289072 A1
(43) Pub. Date: Sep. 25, 2014

(54) METHODS, SYSTEMS AND COMPUTER-READABLE MEDIA FOR RECOMMENDING A SHOPPING PATH

(71) Applicant: Infosys Limited, Bangalore (IN)

(72) Inventors: Satyabrata Pradhan, Khurda (IN); Radha Krishna Pisipati, Hyderabad (IN); Kishore Jonna, Cuddapah (IN); Swapna Sourav Rout, Lingraj Temple (IN)

(73) Assignee: Infosys Limited, Bangalore (IN)

(21) Appl. No.: 14/220,355

(22) Filed: Mar. 20, 2014

(30) Foreign Application Priority Data
Mar. 21, 2013 (IN) 1231/CHE/2013

(51) Int. Cl. G06Q 30/06

(52) U.S. Cl. CPC G06Q 30/0639; G06Q 30/0633
USPC 705/26.8

(57) ABSTRACT

The present invention provides a method and system for recommending an optimal shopping path to a user. A shopping layout of a shopping store is downloaded on a handheld device. A shopping list is received from the user, comprising one or more shopping items. A final shopping list is created by appending one or more additional shopping items to the shopping list. The optimal shopping path representing a shortest path on the shopping layout traversing each shopping item of the final shopping list is generated.

This application claims the benefit of Indian Patent Application Filing Number 1231/CHE/2013, filed on Mar. 21, 2013, which is hereby incorporated by reference in its entirety.

### FIELD OF THE INVENTION

The present invention relates generally to a method and system for assisting a customer in shopping at a retail outlet. More specifically, the present invention relates to a method and system for recommending the customer an optimal shopping path for shopping items at the retail outlet.

### BACKGROUND

Currently an impediment in retail shopping experience is the congestion and delays present while buying items in real time from shopping malls and retail outlets. Additionally, a lot of time gets spent in deciding which shopping items to purchase, and in searching for the shopping items in the shopping mall. A customer usually loses time in searching for the shopping items in the various item shelves present in the shopping mall, used for stocking the shopping items. Despite the presence of sales staff, their number usually turns out to be inadequate in guiding all the customers. Absence of proper guidance to the customers results in overcrowding of the shopping mall, and inefficient usage of space and time.

Certain existing technologies provide the customer with a printed map, based on a shopping list of the customer, indicating the positions of the shopping items in the shopping mall. However, the printed map is static and cannot be dynamically changed when the customer changes the shopping list. Each time the customer adds a shopping item to the shopping list, the customer would have to take another printed map that shall include the added shopping item. Hence the existing technologies do not provide dynamic routing to the customer that shall assist the customer in searching for shopping items, when the shopping list is dynamically updated.

Hence there is a need for an alternative method and a system that can provide a dynamic optimal shopping path to the customer, for aiding the customer in searching for shopping items in a shopping mall. The alternative method must enable the customers in reducing the congestion present in the retail outlets and thereby increase retail patronage and market sales. Thus a method for recommending an optimal shopping path to the customer in a shopping mall is proposed.

### SUMMARY

The present invention provides a method and system for recommending a shopping path. In accordance with a disclosed embodiment, the method may include downloading a shopping layout of a shopping store on a handheld device. A shopping list comprising one or more shopping items is received on a handheld device. A final shopping list is created by appending one or more additional shopping items to the shopping list. A shopping path is generated based on the final shopping list, where the shopping path includes a shortest path, on the shopping layout, traversing each shopping item of the final shopping list.

In an additional embodiment, a system for recommending a shopping path is disclosed. The system comprises an application interface configured to download a shopping layout of a shopping store on a handheld device, and create a shopping list from one or more shopping items selected by a user. A recommendation engine is configured to recommend one or more additional shopping item. Further, a compiling module is configured to create a final shopping list by appending one or more of the one or more additional shopping items to the shopping list. A dynamic navigation engine is configured to create the shopping path based on the final shopping list, where, the shopping path includes a shortest path on the shopping layout traversing each shopping item of the final shopping list.

These and other features, aspects, and advantages of the present invention will be better understood with reference to the following description and claims.

### BRIEF DESCRIPTION OF THE DRAWINGS

FIG. 1 shows an exemplary system for recommending a shopping path.

FIG. 2 is a flowchart illustrating an embodiment of a method of recommending a shopping path.

FIG. 3 is a flowchart illustrating a preferred embodiment of a method of recommending a shopping path.

FIG. 4 illustrates an exemplary shopping path.

FIG. 5 illustrates a generalized example of a computing environment 500.

While systems and methods are described herein by way of example and embodiments, those skilled in the art recognize that systems and methods for electronic financial transfers are not limited to the embodiments or drawings described. It should be understood that the drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include”, “including”, and “includes” mean including, but not limited to.

### DETAILED DESCRIPTION

Disclosed embodiments provide computer-implemented methods, systems, and computer-program products for recommending an optimal shopping path to a user. The methods disclosed herein, incorporate dynamic programming for calculating an optimal shopping path in a shopping mall. The optimal shopping path is usually a shortest path among a plurality of item nodes in the shopping mall, where the plurality of item nodes represents a plurality of shopping items intended to be purchased by the user.

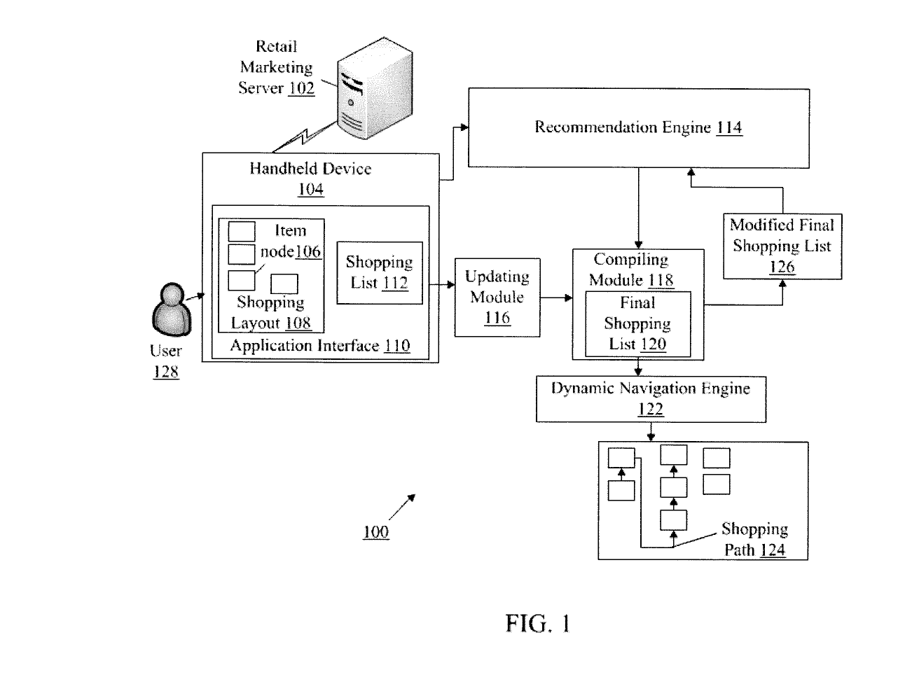

FIG. 1 illustrates an exemplary system 100 in which various embodiments of the invention can be practiced. The exemplary system 100 includes a retail marketing server 102, a handheld device 104, a recommendation engine 114, an updating module 116, a compiling module 116, and a dynamic navigation engine 122. The handheld device can be a cell phone, a mobile device, a PDA, or any other electronic device capable of wireless communication. The handheld device 104 is usually registered with a retail marketing server 102. The retail marketing server 102 can store a list of cities where the user 128 may navigate to, a list of shopping stores in each of the cities, and a shopping layout of each of the shopping stores. The handheld device 104 can include an application interface 110 via which the user 128, may select a city of choice. The application interface 110 can retrieve a shopping store list of the selected city of choice, from the retail marketing server 102, where the shopping store list comprises a list of all the shopping stores in the selected city. As per inputs from the user 128, a shopping store can be selected from the shopping store list. The application interface 110 can download a shopping layout 108 of the selected shopping store, from the retail marketing server 102, on the handheld device 104. The shopping layout 108, usually includes a schematic representation of all shopping items of the selected shopping store, as maybe present in real time within the selected shopping store.

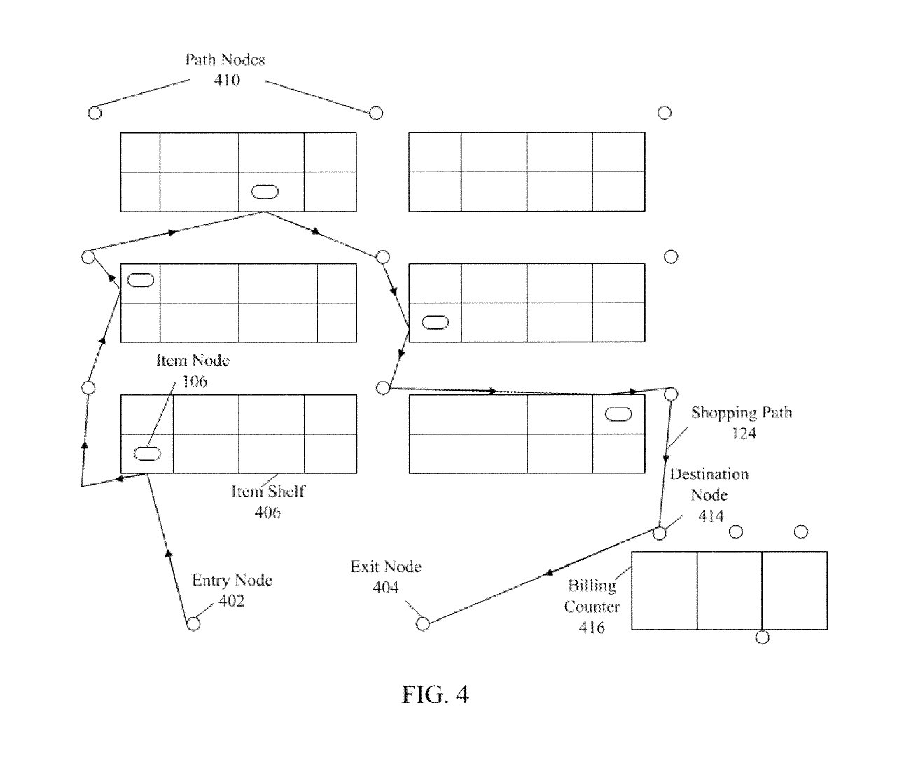

FIG. 4 illustrates an exemplary shopping path. Each item is represented as an item node 106 on the shopping layout 108. The item node 106 is usually present on an Item Shelf 406, as depicted. An entrance to the shopping store can be represented as an entry node 402, an exit as an exit node 404 as a destination node 414, and a billing counter 416 where the user 128, shall make the payment for the shopping items. Additionally, one or more path nodes 410 can be illustrated on the shopping layout 108, to represent a junction where two or more pathways interlink. The one or more path nodes 410 are essential in completing the shopping path 124.

The user 128, may select one or more shopping items, to be purchased from the selected shopping store. The application interface 110 can be configured to create a shopping list from the one or more shopping items selected by the user 128.

The recommendation engine 114 can be configured to recommend one or more additional shopping items to the user 128, based on a set of previous buying patterns of the user and a set of general buying patterns of a plurality of previous customers. The recommendation engine 114, may be additionally configured to suggest an alternative to a shopping item, when the shopping item is unavailable in the shopping store. The compiling module 118 can create a final shopping list 120 by appending one or more of the one or more additional shopping items to the shopping list. The dynamic navigation engine 122, is configured to run an algorithm for creating a shopping path 124 based on the final shopping list 120, that maybe provided by the compiling module 118. The shopping path 124 is usually, a shortest path on the shopping layout 108 traversing each shopping item of the final shopping list 120. The shopping path 124 is usually the recommended path; the user could follow, for purchasing the shopping items in the final shopping list 120.

In the disclosed embodiment, a mathematical notation of the algorithm for creating the shopping path 124 can be described as: pathcost(S,D,(itemset{A→Z}))=min{pathcost(S,i,(itemSet-{i}))+Dist(i,D)}, where S represents a source node, such as the entry node 402, D represents the destination node 414, such as the exit node 404, on the shopping layout 108, itemset represents a set of all items each of which is considered as the item node 106, and Dist(i,D) represents the shortest distance from node ‘i’ to node ‘D’.

The user 128 may choose to update the final shopping list 120 by adding or deleting certain shopping items from the final shopping list 120. In such a case, the updating module 116 can modify the final shopping list 120, based on an input from the user 128, to create a modified final shopping list 126. The recommendation engine 114, can be configured to receive the modified final shopping list 126, to recommend one or more additional shopping items to the modified shopping list 126. The dynamic navigation engine 122, can update the shopping path 124, based on the modified final shopping list 126.

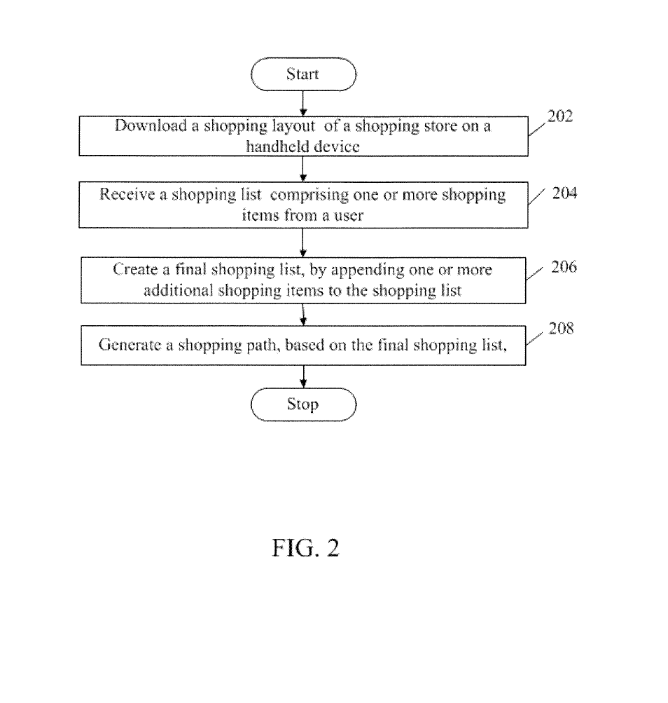

FIG. 2 is a flowchart that illustrates a method performed in recommending an optimal shopping path in accordance with an embodiment of the present invention. At step 202, a shopping layout of the shopping store is downloaded on a handheld device. A shopping list comprising a set of shopping items required to be purchased by a user, is received from the user as in input to the handheld device, at step 204. Further at step 206, a final shopping list is created, by appending one or more additional shopping items to the shopping list. A shopping path is generated, based on the final shopping list at step 208. The shopping path is usually an optimally generated path that may guide the user for purchasing all the shopping items in the final shopping list, by following the shortest path in the shopping store.

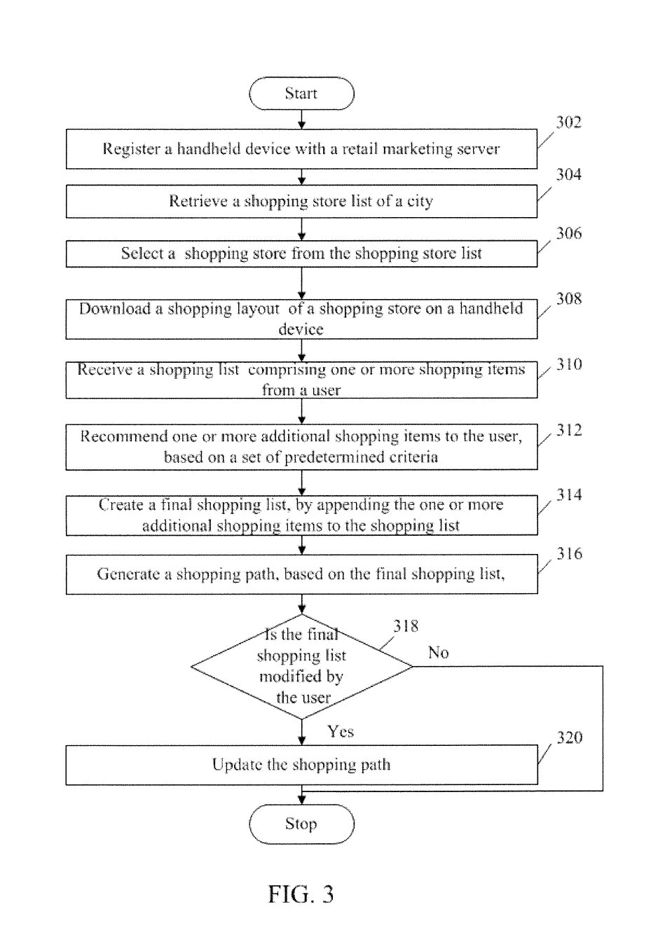

FIG. 3 illustrates an alternate embodiment of a method of practicing the instant invention. At step 302, a handheld device is registered with a retail marketing server. The retail marketing server usually stores information on each shopping store present in a city. At step 304, the user may choose to retrieve a shopping store list comprising a list of all the shopping stores present in the city. At step 306, a shopping store can be selected from the shopping store list. At step 308, a shopping layout of the shopping store can be downloaded on the handheld device. At step 310, a shopping list comprising one or more shopping items required to be purchased, is received from the user on the handheld device. One or more additional items may be recommended to the user, at step 312, based on a set of predetermined criteria. The set of predetermined criteria may include a set of previous buying patterns of the user and a set of general buying patterns of previous users of the shopping store. At step 314, a final shopping list can be created, by appending the one or more additional shopping items to the shopping list. Based on the final shopping list, a shopping path is generated at step 316. In an event the final shopping list is modified by the user, by adding one or more additional shopping items to the final shopping list, the shopping path can be updated dynamically at step 320. The user may then follow the dynamically updated shopping path for completing the shopping.

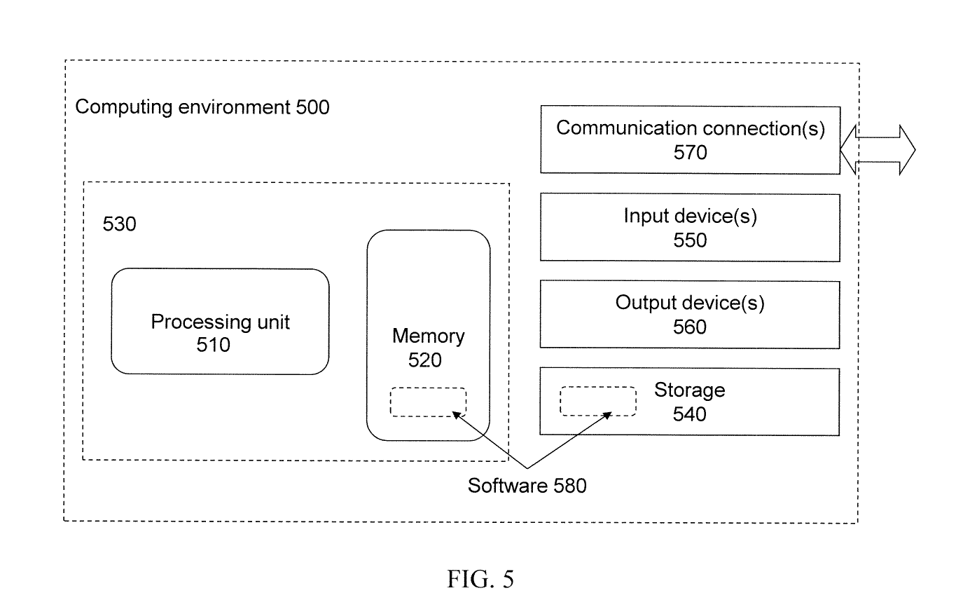

One or more of the above-described techniques can be implemented in or involve one or more computer systems. FIG. 5 illustrates a generalized example of a computing environment 500. The computing environment 500 is not intended to suggest any limitation as to scope of use or functionality of described embodiments.

With reference to FIG. 5, the computing environment 500 includes at least one processing unit 510 and memory 520. In FIG. 5, this most basic configuration 430 is included within a dashed line. The processing unit 510 executes computer-executable instructions and may be a real or a virtual processor. In a multi-processing system, multiple processing units execute computer-executable instructions to increase processing power. The memory 520 may be volatile memory (e.g., registers, cache, RAM), non-volatile memory (e.g., ROM, EEPROM, flash memory, etc.), or some combination of the two. In some embodiments, the memory 520 stores software 580 implementing described techniques.

A computing environment may have additional features. For example, the computing environment 500 includes storage 540, one or more input devices 540, one or more output devices 560, and one or more communication connections 570. An interconnection mechanism (not shown) such as a bus, controller, or network interconnects the components of the computing environment 500. Typically, operating system software (not shown) provides an operating environment for other software executing in the computing environment 500, and coordinates activities of the components of the computing environment 500.

The storage 540 may be removable or non-removable, and includes magnetic disks, magnetic tapes or cassettes, CD-ROMs, CD-RWs, DVDs, or any other medium which can be used to store information and which can be accessed within the computing environment 500. In some embodiments, the storage 540 stores instructions for the software 580.

The input device(s) 550 may be a touch input device such as a keyboard, mouse, pen, trackball, touch screen, or game controller, a voice input device, a scanning device, a digital camera, or another device that provides input to the computing environment 500. The output device(s) 560 may be a display, printer, speaker, or another device that provides output from the computing environment 500.

The communication connection(s) 570 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 500, computer-readable media include memory 520, storage 540, communication media, and combinations of any of the above.

Having described and illustrated the principles of our invention with reference to described embodiments, it will be recognized that the described embodiments can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

As will be appreciated by those ordinary skilled in the art, the foregoing example, demonstrations, and method steps may be implemented by suitable code on a processor base system, such as general purpose or special purpose computer. It should also be noted that different implementations of the present technique may perform some or all the steps described herein in different orders or substantially concurrently, that is, in parallel. Furthermore, the functions may be implemented in a variety of programming languages. Such code, as will be appreciated by those of ordinary skilled in the art, may be stored or adapted for storage in one or more tangible machine readable media, such as on memory chips, local or remote hard disks, optical disks or other media, which may be accessed by a processor based system to execute the stored code. Note that the tangible media may comprise paper or another suitable medium upon which the instructions are printed.

For instance, the instructions may be electronically captured via optical scanning of the paper or other medium, then compiled, interpreted or otherwise processed in a suitable manner if necessary, and then stored in a computer memory.

The following description is presented to enable a person of ordinary skill in the art to make and use the invention and is provided in the context of the requirement for a obtaining a patent. The present description is the best presently-contemplated method for carrying out the present invention. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

While the foregoing has described certain embodiments and the best mode of practicing the invention, it is understood that various implementations, modifications and examples of the subject matter disclosed herein may be made. It is intended by the following claims to cover the various implementations, modifications, and variations that may fall within the scope of the subject matter described.

We claim:

1. A method for recommending a shopping path, the method comprising:
downloading, by a mobile computing device, a shopping layout of a shopping store;
receiving, by the mobile computing device, a shopping list from a user, whereby the shopping list comprises one or more shopping items;
creating, by the mobile computing device, a final shopping list, by appending one or more additional shopping items to the shopping list; and
generating, by the mobile computing device, the shopping path based on the final shopping list, whereby the shopping path includes a shortest path on the shopping layout traversing each shopping item of the final shopping list.

2. The method of claim 1, further comprising:
recommending, by the mobile computing device, the one or more additional shopping items to the user, based on a set of predetermined criteria; and
updating, by the mobile computing device, the shopping path when the final shopping list is modified by the user.

3. The method of claim 1, further comprising:
registering, by the mobile computing device, with a retail marketing server;
retrieving, by the mobile computing device, a shopping store list of a city, whereby the city is selected by the user; and
selecting, by the mobile computing device, the shopping store from the shopping store list.

4. The method of claim 1, wherein the shopping layout comprises one or more of a plurality of item nodes, a plurality of path nodes, one or more entry nodes, or one or more destination nodes.

5. The method of claim 4, wherein:
a destination node includes a billing counter of the shopping store;
an entry node is an entrance to the shopping store;
an item node is a shopping item; and
a path node is a junction of the shopping path.

6. The method of claim 2, wherein the set of predetermined criteria comprises: a set of previous buying patterns of the user, and a set of general buying patterns.

7. The method of claim 1, further comprising suggesting, by the mobile computing device, an alternative to a shopping item, when the shopping item is unavailable.

8. A mobile computing device comprising:
a processor;
a memory, wherein the memory coupled to the one or more processors which are configured to execute programmed instructions stored in the memory comprising:
downloading a shopping layout of a shopping store;
receiving a shopping list from a user, whereby the shopping list comprises one or more shopping items;
creating a final shopping list, by appending one or more additional shopping items to the shopping list; and
generating the shopping path based on the final shopping list, whereby the shopping path includes a shortest path on the shopping layout traversing each shopping item of the final shopping list.

9. The device of claim 8, further comprising:
recommending the one or more additional shopping items to the user, based on a set of predetermined criteria; and
updating the shopping path when the final shopping list is modified by the user.

10. The device of claim 8, further comprising:
registering with a retail marketing server;
retrieving a shopping store list of a city, whereby the city is selected by the user; and
selecting the shopping store from the shopping store list.

11. The device of claim 8, wherein the shopping layout comprises a plurality of item nodes, a plurality of path nodes, one or more entry nodes, and one or more destination nodes.

12. The device of claim 11, wherein:
a destination node includes a billing counter of the shopping store;
an entry node is an entrance to the shopping store;
an item node represents a shopping item; and
a path node represents a junction of the shopping path.

13. The device of claim 9, wherein the set of predetermined criteria comprises one or more of a set of previous buying patterns of the user, or a set of general buying patterns.

14. The device of claim 8, further comprising suggesting an alternative to a shopping item, when the shopping item is unavailable.

15. A non-transitory computer readable medium having stored thereon instructions for recommending a shopping path comprising machine executable code which when executed by at least one processor, causes the processor to perform steps comprising:
downloading a shopping layout of a shopping store on a handheld device;
receiving a shopping list from a user, whereby the shopping list comprises one or more shopping items;
creating a final shopping list, by appending one or more additional shopping items to the shopping list; and
generating the shopping path, based on the final shopping list, whereby the shopping path includes a shortest path on the shopping layout traversing each shopping item of the final shopping list.

16. The medium as set forth in claim 15 further comprising:
recommending the one or more additional shopping items to the user, based on a set of predetermined criteria;
updating the shopping path when the final shopping list is modified by the user;
registering with a retail marketing server;
retrieving a shopping store list of a city, whereby the city is selected by the user; and
selecting the shopping store from the shopping store list.

17. The medium as set forth in claim 15 wherein the shopping layout comprises a plurality of item nodes, a plurality of path nodes, one or more entry nodes, and one or more destination nodes.

18. The medium as set forth in claim 17 wherein:
a destination node includes a billing counter of the shopping store;
an entry node is an entrance to the shopping store;
an item node represents a shopping item; and
a path node represents a junction of the shopping path.

19. The medium as set forth in claim 16 wherein the set of predetermined criteria comprises one or more of a set of previous buying patterns of the user, or a set of general buying patterns.

20. The medium as set forth in claim 15 further comprising suggesting an alternative to a shopping item, when the shopping item is unavailable.
